(19) United States
(12) Patent Application Publication
(10) Pub. No.: US 2012/0293554 A1
(43) Pub. Date: Nov. 22, 2012

(54) IMAGE DISPLAY METHOD AND APPARATUS FOR SAME, AND RECORDING MEDIUM

(75) Inventors: Kentaro HARADA, Yokohama-shi (JP); Masahiko INAKAGE, Tokyo (JP); Sayako SUZUKI, Tokyo (JP); Maki SUGIMOTO, Tokyo (JP); Makoto DANJYO, Tokyo (JP); Rika MATSUI, Tokyo (JP); Takashi NAOI, Tokyo (JP)

(73) Assignees: KEIO UNIVERSITY, Tokyo (JP); OLYMPUS CORPORATION, Tokyo (JP)

(21) Appl. No.: 13/478,334

(22) Filed: May 23, 2012

Related U.S. Application Data
(63) Continuation of application No. PCT/JP2010/071141, filed on Nov. 26, 2010.

(30) Foreign Application Priority Data
Nov. 27, 2009 (JP) 2009-270568

(51) Int. Cl. G09G 5/00

(52) U.S. Cl. 345/660

(57) ABSTRACT

An image display method for displaying images in layouts having a hierarchic structure of each layout is disclosed. The each layout is geometrically similar each other. A lower layer layout is enlarged to cover and hide an upper layer layout. At least one region of the lowest layout is divided by applying the layout to generate new regions and images are displayed in the new regions. The above process is repeated more than once.

### CROSS-REFERENCE TO RELATED APPLICATIONS

This application is a Continuation Application of PCT Application No. PCT/JP2010/071141, filed Nov. 26, 2010 and based upon and claiming the benefit of priority from prior Japanese Patent Application No. 2009-270568, filed Nov. 27, 2009, the entire contents of all of which are incorporated herein by reference.

### BACKGROUND OF THE INVENTION

1. Field of the Invention

The present invention relates to an image display method and an apparatus for the same to switch and sequentially display multiple images such as still images or moving images, and also relates to a recording medium.

2. Description of the Related Art

There has heretofore been known an image display technique for switching and sequentially displaying multiple images. For example, a digital photoframe switches and successively displays multiple images recorded in a recording medium.

During image viewing, the digital photoframe basically displays one image while successively switching multiple images. When switching to the next image from the image being displayed, the digital photoframe instantaneously switches the images or gradually replaces the image being displayed by the next image. When the image is gradually replaced, two images are partially displayed at the same time during the switch of the images. That is, the digital photoframe has two display modes: (1) to only display one complete image (during image viewing), and (2) to simultaneously display two partial images (during the switch of the images). For example, Jpn. Pat. Appln. KOKAI Publication No. 2009-81733 discloses a technique for presenting a story-like slide show. Jpn. Pat. Appln. KOKAI Publication No. 2009-81733 discloses that, for example, images displayed in a slide show are sequentially displayed to a tune, and metadata for an image is used to associate images before and after the former image with each other. Jpn. Pat. Appln. KOKAI Publication No. 2009-81733 discloses that the metadata for the image being reproduced serves as a query for the image to be reproduced next, and an image is acquired and selected from the related term of the query to switch images.

### BRIEF SUMMARY OF THE INVENTION

An image display method according to one aspect of the present invention displays images in layouts having a hierarchic structure of each layers of a layout. Substantially, the each layers of the layout is similar in geometrical means each other. A lower layer layout is enlarged to cover an upper layer layout and at least one region of the lowest layout is divided according to the layout to generate new regions. By repeating this process, lower layers are hiding upper layers and new small layers are being generated one after another.

In more specific way, an image display method according to one aspect of the present invention comprises: displaying, on a display, multiple images in regions divided by layouts having a hierarchic structure of each layout, each layout being substantially similar in geometric means from an upper layer to a lower layer each other; and repeating processing more than once to sequentially switch displayed images, the processing comprising, (1) enlarging each of the images displayed in each of the regions of a particular layer and layers lower than the particular layer, the particular layer not being the uppermost layer, so that the positional relationship and aspect ratio of each of the images are not changed and so that the size and position of the layout of the particular layer after the enlargement correspond to the size and position of the layout of the uppermost layer before the enlargement, (2) quitting displaying of the images in the regions of the layers higher than the particular layer but not included in the regions of the particular layer and the layers lower than the particular layer, (3) dividing at least one region of the lowermost layer by applying the layout to the at least one region to generate new regions, and (4) displaying images in the generated regions.

An image display apparatus according to aspect of the present invention comprises a displaying unit having functions of: displaying, on a display, multiple images in regions divided by layouts having a hierarchic structure of each layout, each layout being substantially similar in geometric means from an upper layer to a lower layer each other; and repeating processing more than once to sequentially switch displayed images, the processing comprising, (1) enlarging each of the images displayed in each of the regions of a particular layer and layers lower than the particular layer, the particular layer not being the uppermost layer, so that the positional relationship and aspect ratio of each of the images are not changed and so that the size and position of the layout of the particular layer after the enlargement correspond to the size and position of the layout of the uppermost layer before the enlargement, (2) quitting displaying of the images in the regions of the layers higher than the particular layer but not included in the regions of the particular layer and the layers lower than the particular layer, (3) dividing at least one region of the lowermost layer by applying the layout to the at least one region to generate new regions, and (4) displaying images in the generated regions.

A computer-readable recording medium according to aspect of the present invention, the image display program causing a computer to: display, on a display, multiple images in regions divided by layouts having a hierarchic structure of each layout, each layout being substantially similar in geometric means from an upper layer to a lower layer each other; and repeat processing more than once to sequentially switch displayed images, the processing comprising, (1) enlarging each of the images displayed in each of the regions of a particular layer and layers lower than the particular layer, the particular layer not being the uppermost layer, so that the positional relationship and aspect ratio of each of the images are not changed and so that the size and position of the layout of the particular layer after the enlargement correspond to the size and position of the layout of the uppermost layer before the enlargement, (2) quitting displaying of the images in the regions of the layers higher than the particular layer but not included in the regions of the particular layer and the layers lower than the particular layer, and (3) dividing at least one region of the lowermost layer by applying the layout to the at least one region to generate new regions, and (4) displaying images in the generated regions.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a first embodiment of an image display apparatus according to the present invention;

FIG. 2 is a functional block diagram of the same apparatus;

FIG. 3 is a diagram showing regions divided into layouts by a first display unit in the same apparatus;

FIG. 4A is a diagram showing the layout of an uppermost layer in the same apparatus;

FIG. 4B is a diagram showing the layout of a second layer in the same apparatus;

FIG. 4C is a diagram showing the layout of a third layer in the same apparatus;

FIG. 4D is a diagram showing the layout of a fourth layer in the same apparatus;

FIG. 5 is a diagram showing the flow of image display processing such as the enlargement of images including the layouts of the layers by a second display unit in the same apparatus;

FIG. 6 is a flowchart for image display in the same apparatus;

FIG. 7 is a diagram showing regions divided by layouts in the first display unit in a second embodiment of the image display apparatus according to the present invention;

FIG. 8A is a diagram showing the layout of the uppermost layer in the same apparatus;

FIG. 8B is a diagram showing the layout of the second layer in the same apparatus;

FIG. 8C is a diagram showing the layout of the third layer in the same apparatus;

FIG. 8D is a diagram showing the layout of the fourth layer in the same apparatus; and

FIG. 9 is a diagram showing the flow of image display processing such as the enlargement of images including the layouts of the layers by the second display unit in the same apparatus.

### DETAILED DESCRIPTION OF THE INVENTION

A first embodiment of the present invention will be described hereinafter with reference to the drawings.

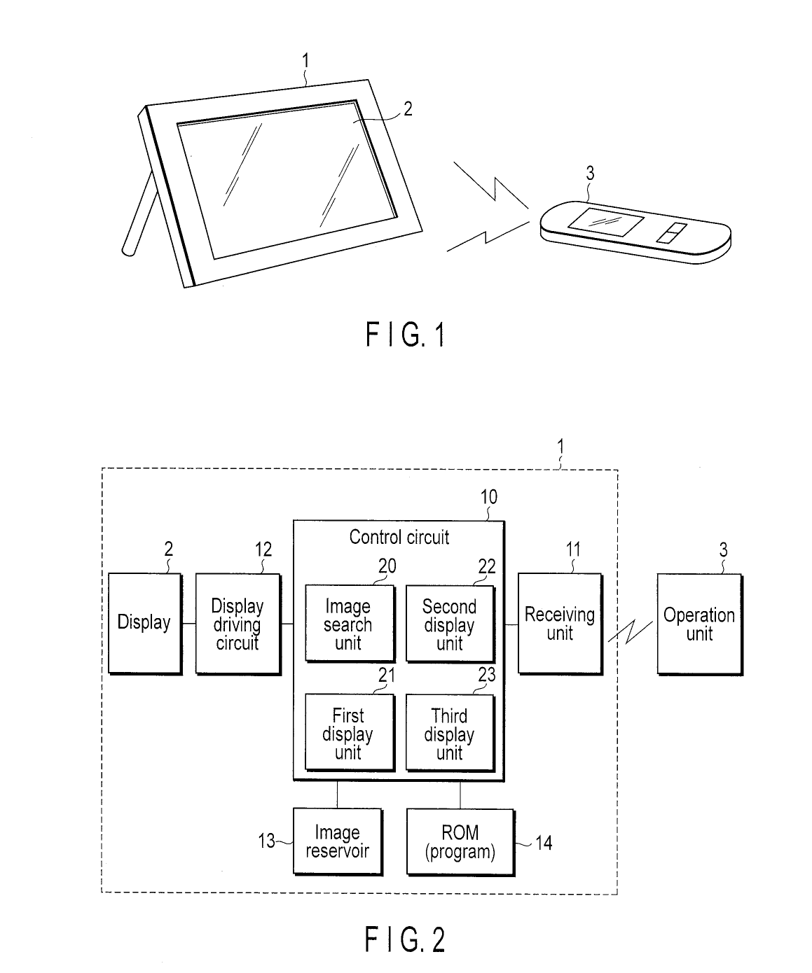

FIG. 1 shows a perspective view of an image display apparatus 1. Although a photoframe is described as an example of the image display apparatus 1, the image display apparatus 1 is not limited thereto and can be widely used for other purposes. For example, the image display apparatus 1 can be used for the display of image information on a large-sized screen at an exhibition, for the reproduction of image information recorded in a recording medium such as a DVD or a Blue-ray Disc (registered trademark), and for the reproduction of image information distributed by broadcasting or on the Internet.

The image display apparatus 1 includes a display 2 comprising liquid crystal. The image display apparatus 1 simultaneously displays multiple images on a display screen of the display 2, and sequentially switches the displayed images. The image display apparatus 1 incessantly and sequentially displays multiple images on the display 2, for example, in response to the operation of an operation unit 3 by a user. The operation unit 3 is, for example, a remote controller.

FIG. 2 shows a functional block diagram of the image display apparatus 1. The image display apparatus 1 includes a control circuit 10 comprising at least one electronic circuit. The control circuit 10 includes a computer having, for example, a CPU. A receiving unit 11, a display driving circuit 12, an image store 13 as a recording medium, and a program ROM 14 are connected to the control circuit 10. The receiving unit 11 wirelessly communicates with the operation unit 3. The receiving unit 11 receives operational information emitted from the operation unit 3, and sends this operational information to the control circuit 10. The display 2 is connected to the display driving circuit 12. The display driving circuit 12 drives the display 2 to display images. On receipt of an image display instruction from the control circuit 10, the display driving circuit 12 simultaneously displays multiple images on the display screen, and sequentially switches images and displays the switched images one after another.

Multiple images are stored in the image store 13. The image store 13 includes, for example, a recording medium such as a hard disk drive. In the present embodiment, the image store 13 is incorporated in the image display apparatus 1, but can be placed far from the image display apparatus 1. In this case, the image store 13 may be connected to the image display apparatus 1 via a communication line such as a network, and may communicate with the image display apparatus 1 to transmit image data.

The control circuit 10 includes a function of an image search unit 20. The image search unit 20 searches the multiple images stored in the image store 13 for images associated with one another. The associated images include, for example, images taken around the same time, and images having associations in time or story-like images. The image search unit 20 searches for images associated with one another, for example, in accordance with information on the date and time of imaging, text data, tags, and keywords that are attached to the image data. Alternatively, the image search unit 20 searches for images associated with one another, for example, by information regarding, for example, feature points, shapes, and colors in the images. The images associated with one another may be stored in the image store 13 in advance.

An image display program is stored in the program ROM 14 in advance. The image display program simultaneously displays multiple images on the display screen in the display 2, and sequentially switches the displayed images. The image display program causes the control circuit 10 to execute a first display function and a second display function.

The first display function includes displaying each of the images in regions divided by geometrically similar layouts from an upper layer to a lower layer. The layouts have a hierarchic structure of each layout.

The second display function includes (1) enlarging each of the images displayed in each regions of a particular layer and layers lower than a particular layer at the same ratio so that the positional relationship and aspect ratio of each of the images are not changed and so that the size and position of the layout of the particular layer after enlargement correspond to the size and position of the layout of the uppermost layer before enlargement.

The second display function also includes (2) quitting displaying of the images in the regions of the layers higher than the particular layer but not included in the regions of the particular layer and the layers lower than the particular layer, (3) dividing at least one region of the lowermost layer by applying the layout to the at least one region to generate new regions, and (4) displaying images in the generated regions.

The image display program causes the control circuit 10 to repeat the second display function more than once.

The control circuit 10 accesses the image store 13 and the program ROM 14 and sends instructions to the receiving unit 11 and the display driving circuit 12, and performs a series of controls to altering-display of multiple images on the display 2. The control circuit 10 reads and executes the image display program stored in the program ROM 14, and thereby includes the functions of a first display unit 21, a second display unit 22, and a third display unit 23.

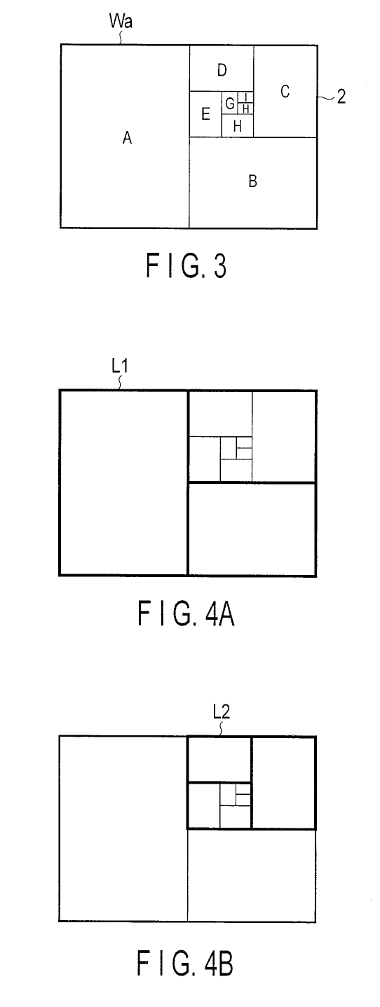

The first display unit 21 performs the first display function described above. The first display unit displays images on the display 2 in similar layouts (hereinafter abbreviated as layouts) that are nested from the upper layer to the lower layer as shown in FIG. 3. The layouts include regions A, B, C, . . . , I that divide a rectangular frame Wa. The frame Wa corresponds to, for example, a rectangular shape of the display screen on the display 2.

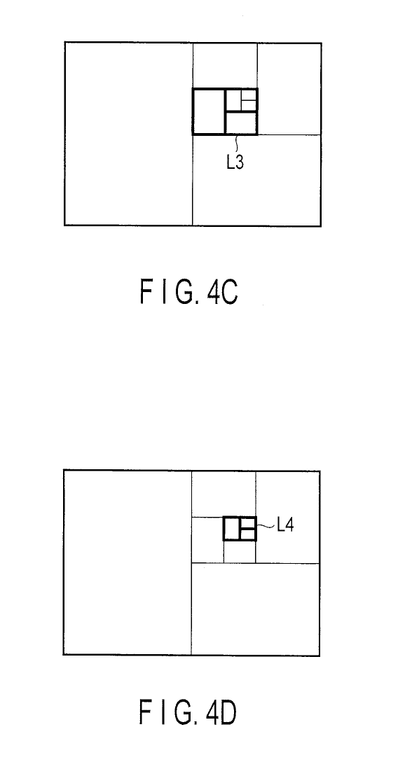

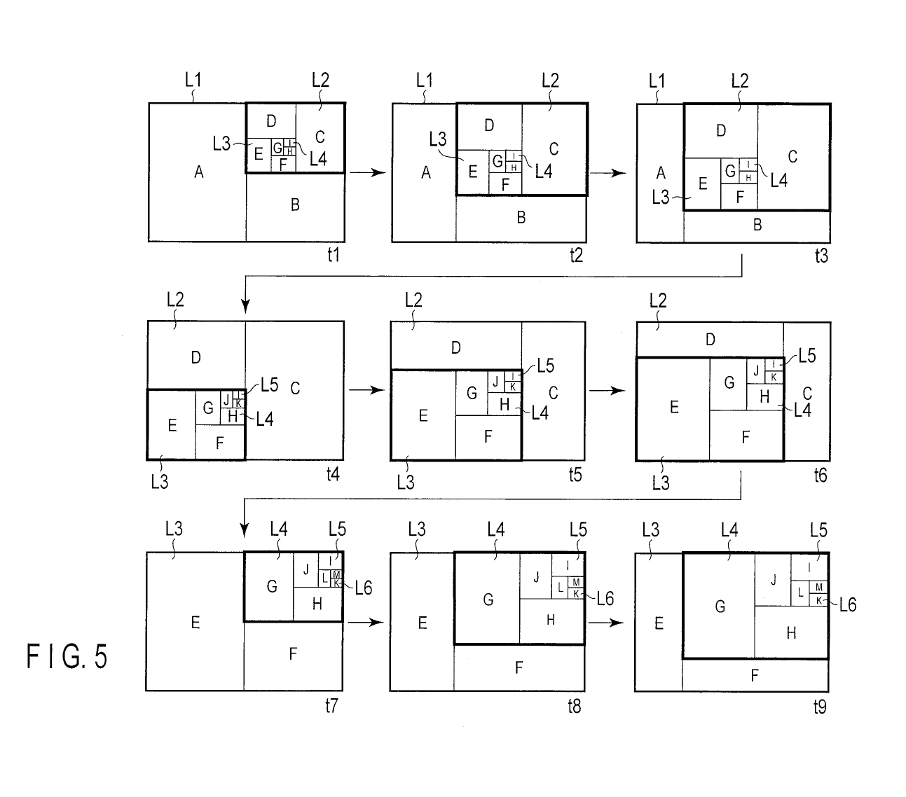

FIG. 4A to FIG. 4D show layouts L1 to L4. Each of layouts L1 to L4 is formed into a rectangular shape, and includes geometrically self-similar layouts in layers. Layout L1 shown in FIG. 4A is the layout of the uppermost layer. Layout L2 shown in FIG. 4B is the layout of the second layer. Layout L3 shown in FIG. 4C is the layout of the third layer. Layout L4 shown in FIG. 4D is the layout of the fourth layer. Layouts L1 to L4 are substantially similar in geometrical means to one another. Therefore, the layouts shown in FIG. 3 include similar layouts L1 to L4 in four layers.

When layout L2 and layouts below layout L2 are enlarged, layout L1 are covered by the enlarged layout L2 and the display of the images in layout L1 is quitted, layout L2 becomes the layout of the uppermost layer, layout L3 becomes the layout of the second layer, and layout L4 becomes the layout of the third layer.

It is preferable that aspect ratio of the outer shape (the shape of the outer frame) of each of layouts L1 to L4 of the respective layers be configured to be the same as the aspect ratio of the display screen of the display 2. Each of layouts L1 to L4 having such a shape can be displayed in the whole screen of the display 2 without any blank.

It is preferable that the outer shape (the shape of the outer frame) of each of layouts L1 to L4 be vertically and horizontally aligned with the display screen of the display 2. Each of layouts L1 to L4 having such a shape does not need to rotate, for example, when enlarged.

It is preferable that aspect ratio of at least one of regions A, B, C, . . . I divided by layouts L1 to L4 be a golden ratio or a silver ratio (1:\sqrt{2}). The silver ratio is known as a highly aesthetic ratio together with the golden ratio.

The number of layouts is not limited to four layers, and there is no limitation in the numbers of layers. The similarity not only includes the relationship of two figures which are congruent when enlarged/reduced or rotated but also includes the relationship of two figures which are mirror images when enlarged/reduced or rotated.

When the image display apparatus 1 is in an image display mode, the first display unit 21 displays, as images, still images or moving images in regions A, B, C, . . . , I divided by layouts L1 to L4.

The second display unit 22 performs (1) and (2) of the second display function and the third display unit performs (3) and (4) part of the second display function described above.

As shown in FIG. 5, the second display unit 22 enlarges (zooms in) each of the images in regions C, . . . , I so that the positional relationship and aspect ratio of each of the images displayed in each of regions C, . . . , I of the layers other than the uppermost layer are not changed and so that the size and position of the layout of the layer one level lower than the uppermost layer after enlargement correspond to the size and position of layout L1 of the uppermost layer before enlargement. In the meantime, the second display unit 22 quits to display the images in the region A and region B, which are included in layout L1 of the uppermost layer but which are not included in layouts L2, L3, and L4 of the layers other than the uppermost layer (non-display). The second display unit 22 repeats, more than once, the processing for enlarging (zooming in) each of the images and the (non-display) processing for not displaying the images.

During the image display by the second display unit 22 or after the end of the image display by the second display unit 22, the third display unit 23 further divides, by the layouts, a part of the region divided by the layout of the lowermost layer, for example, layout L4, thereby generating new regions and displaying images in the new regions.

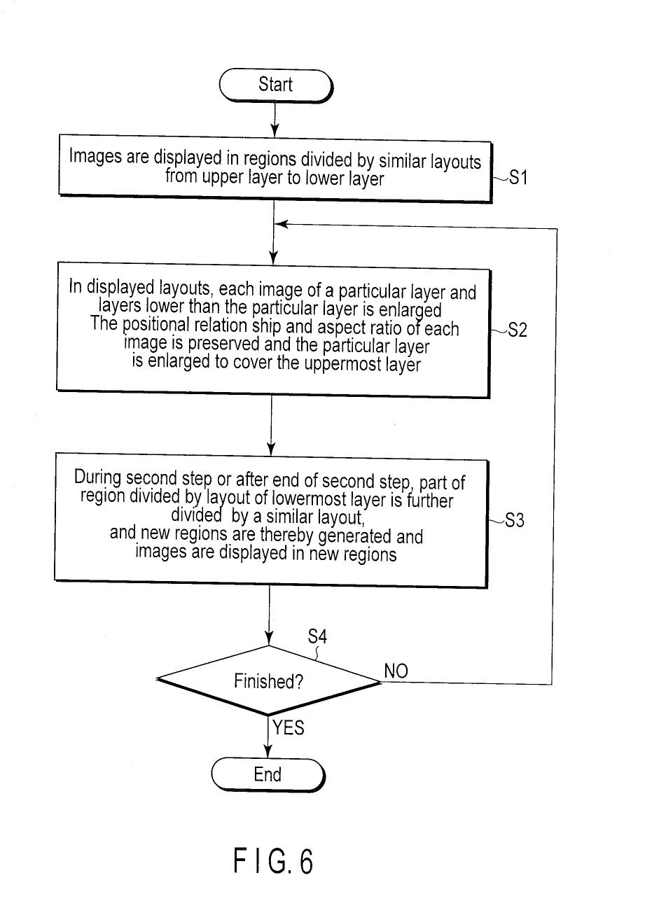

Now, image display operation performed by the apparatus having the above configuration is described with reference to an image display flowchart shown in FIG. 6.

When the user operates the operation unit 3 to give an image display instruction, the operation unit 3 sends an image display instruction. On receipt of the image display instruction from the operation unit 3 through the receiving unit 11, the image display apparatus 1 sets an image display mode. At the same time, the image search unit 20 searches the multiple images stored in the image store 13 for images associated with one another. If images associated with one another are stored in the image store 13 in advance, the image search unit 20 need not search for images associated with one another.

When the image display apparatus 1 is in the image display mode, the first display unit 21 displays images such as still images or moving images associated with one another in regions A, B, C, . . . , I divided by layouts L1 to L4, as shown at t1 in FIG. 5 (step S1).

As shown at time t2 to time t4 in FIG. 5, the second display unit 22 enlarges each of the images in regions C, D, . . . I so that the positional relationship and aspect ratio of each of the images displayed in each of regions C, D, . . . , I of the layers other than the uppermost layer, that is, the second and lower layers are not changed and so that the size and position of the layout of the layer one level lower than the uppermost layer after enlargement correspond to the size and position of layout L1 of the uppermost layer before enlargement. In the meantime, the second display unit 22 quits to display the images in the regions, for example, regions A and B, which are included in layout L1 of the uppermost layer but which are not included in layouts L2, L3, and L4 of the layers other than the uppermost layer.

That is, at time t1 in FIG. 5, the second display unit 22 displays, on the display screen of the display 2, regions C, D, E, F, G, H, and I of layouts L2, L3, and L4 of the second and lower layers as well as regions A and B of layout L1 of the uppermost layer.

As shown in time t2 to time t3 in FIG. 5, with time, the second display unit 22 enlarges layouts L2, L3, and L4 of the second and lower layers without changing the aspect ratio thereof and also enlarges each of the images displayed in each of regions C, D, . . . I of layouts L2, L3, and L4. The second display unit 22 enlarges layouts L2, L3, and L4, and as shown in time t4 in FIG. 5, causes the size of layout L2 of the second layer to be the same as the size of layout L1 of the uppermost layer.

In other words, as shown in time t1 to time t4 in FIG. 5, the second display unit 22 gradually zooms in the region of layout L2 of the second layer and thereby enlarges the region on the display screen of the display 2, and as shown in time t4 in FIG. 5, layout L2 of the second layer occupies the region once layout L1 of the uppermost layer was present. As a result, the images in regions A and B which are included in layout L1 of the uppermost layer but which are not included in layout L2 of the second layer as the subsequent layer are not displayed anymore.

During the image display by the second display unit 22 or after the end of the image display by the second display unit 22, the third display unit 23 further generates a new layout L5 in a part of the region divided by the layout of the lowermost layer, for example, layout L4, as shown in time t4 in FIG. 5. The third display unit 23 divides layout L5 to generate new regions J and K. The third display unit 23 displays images such as still images or moving images associated with one another in the new regions J and K (step S3).

The second display unit 22 determines whether to repeat the processing for enlarging (zooming in) each of the images and the (non-display) processing for not displaying the images.

If the second display unit 22 determines to repeat the processing, the second display unit 22 enlarges layouts L3, L4, and L5 of the third and lower layers without changing the aspect ratio thereof and also enlarges each of the images displayed in each of regions E, F, G, H, I, J, and K of layouts L3, L4, and L5, along with the elapse of time t4 to time t6 shown in FIG. 5.

As shown at time t7 in FIG. 5, the second display unit 22 causes the size of layout L3 of the third layer to be the same as the size of layout L2 of the most recent uppermost layer. That is, the second display unit 22 lays the enlarged layout L3 of the third layer on previous layout L2 of the second layer. As a result, the images in regions C and D which are included in layout L2 of the second layer but which are not included in layout L3 of the third layer are not displayed anymore (step S2).

Again, the third display unit 23 further generates a new layout L6 in a part of the region divided by, for example, layout L5. The third display unit 23 divides layout L6 to generate new regions L and M. The third display unit 23 displays images such as still images or moving images associated with one another in the new regions L and M (step S3).

Subsequently, the second display unit 22 repeats steps S2 and S3, and displays images in the layouts at time t7 to time t9 in FIG. 5.

As described above, according to the first embodiment, images are displayed in regions A, B, C, . . . , I which are divided by layouts L1, L2, . . . , L4. Each of the images is enlarged so that the positional relationship and aspect ratio of each of the images displayed in each of regions C, D, . . . , I of the layers other than the uppermost layer are not changed and so that the size and position of the enlarged layout L2 corresponds to layout L1 of the uppermost layer before the enlargement. The images in the regions which are included in layout L1 of the uppermost layer but which are not included in layouts L2, L3, and L4 of the layers other than the uppermost layer are not displayed anymore. Consequently, associated and story-like multiple images can be displayed as a series of images, in a manner that tiny images are appeared on the display, are enlarged gradually, are disappeared from the display when they reach their maximum size.

As a large number of complete images are simultaneously displayed on the display screen of the display 2, a viewer can recognize the association of the displayed images. The displayed images are enlarged in turn and switched, so that the viewer can expect the image to be enlarged next and can enjoy comfortable viewing.

The number of layers of layouts L1, L2, . . . , L4 can be increased. In this case, for example, the resolution of images can be reduced in the layouts of the layers lower than a predetermined layer so that details of the layers are unrecognizable. In this way, detailed images that have been unrecognizable on the display screen of the display 2 are enlarged in turn. The second display unit 22 raises the resolution of the image displayed in the layout of the layer higher than the predetermined layer to preset resolution. Thus, the image can become to be recognized in detail. The viewer can enjoy the advantage of the images growing into sizes to become recognizable.

As shown in times t1, t4, and t7 in FIG. 5, it is preferable to give a pause for viewing by freezing the changes of, for example, layouts L1, L2, and L3 for a predetermined time when layouts L1, L2, and L3 of the respective layers reach the maximum sizes. When a pause for viewing is given, the images may be displayed as still images at first, but when, for example, layouts L2 and L3 are enlarged and reached their maximum size, the images may start moving to be displayed as moving images so that the moving images can be viewed during the pause for viewing. This permits effective representation.

Now, a second embodiment of the present invention is described with reference to the drawings. The configuration of the image display apparatus 1 is the same as that shown in FIG. 2. The differences are described.

In the present embodiment, the third layer is used as a particular layer instead of the second layer. That is, enlargement (zooming in) starts from a layout L12 of the third layer in contrast with the first embodiment that starts zooming in from layout L2 of the second layer.

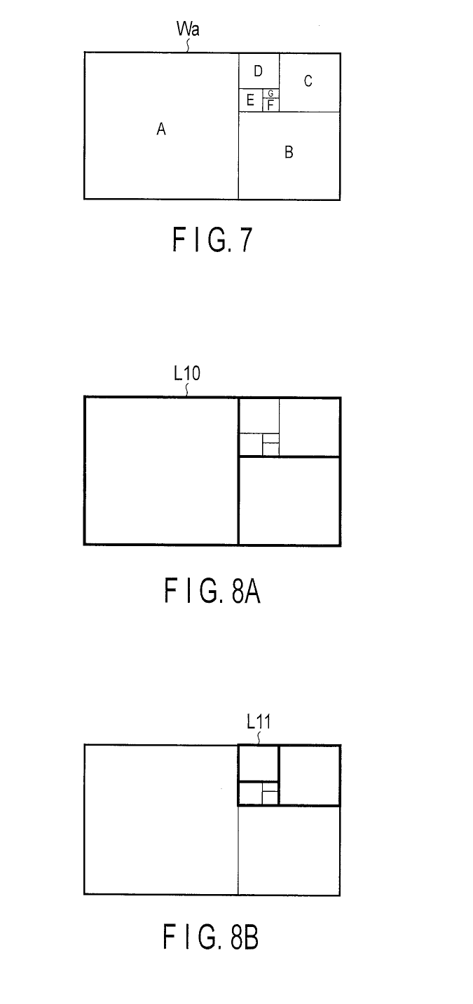

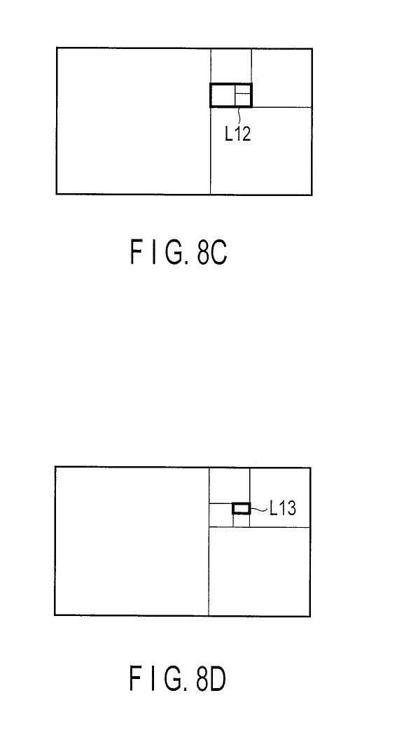

As shown in FIG. 7, the first display unit 21 displays, on the display 2, regions A, B, C, . . . , G divided by similar layouts from the upper layer to the lower layer. FIG. 8A to FIG. 8D show layouts L10 to L13.

Each of layouts L10 to L13 are formed into a rectangular shape to include self-similar layouts in layers. Layout L10 shown in FIG. 8A is the layout of the uppermost layer. Layout L11 shown in FIG. 8B is the layout of the second layer. Layout L12 shown in FIG. 8C is the layout of the third layer. Layout L13 shown in FIG. 8D is the layout of the fourth layer. Layouts L10 to L13 are similar to one another. Therefore, the layouts shown in FIG. 7 include similar layouts L10 to L13 in four layers. The aspect ratio of the outer shape (the shape of the outer frame) of each of layouts L10 to L13 is configured to be the same as the aspect ratio of the display screen.

The first display unit 21 displays images such as still images or moving images associated with one another in regions A, B, C, . . . , G divided by layouts L10 to L13.

The second display unit 22 enlarges (zooms in) each of the images from layout L12 of the third layer.

Now, image display operation performed by the apparatus having the above configuration is described.

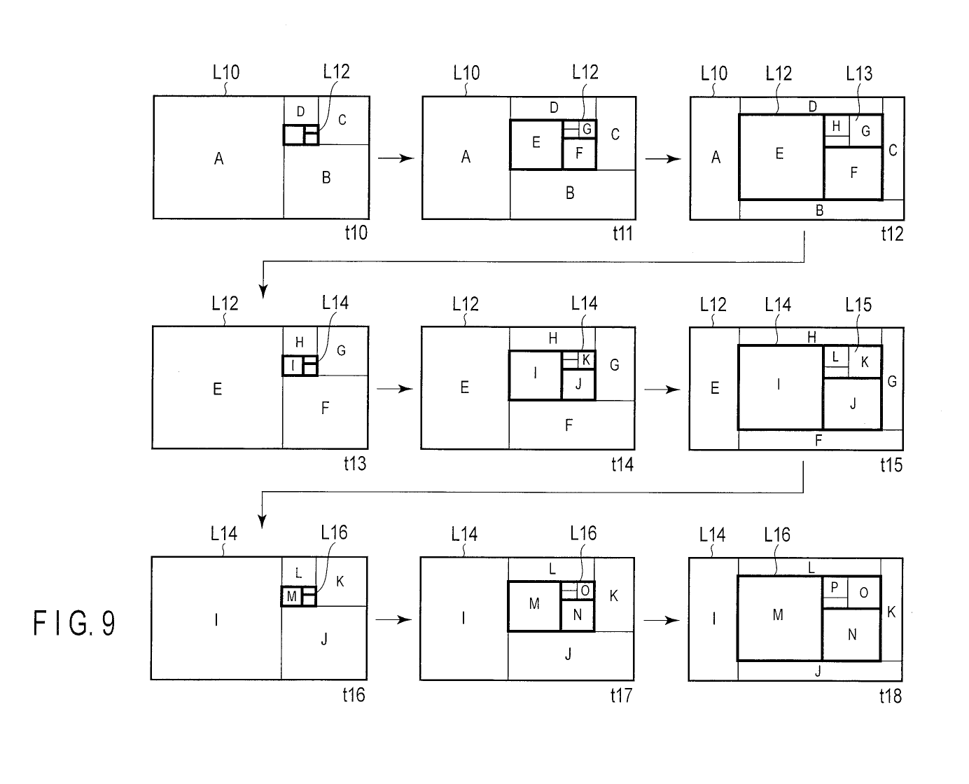

When the image display apparatus 1 is in the image display mode, the first display unit 21 displays images such as still images or moving images associated with one another in regions A, B, C, . . . , G divided by layouts L10 to L13, as shown at time t10 in FIG. 9 (step S1).

As shown at time t11 to time t12 in FIG. 9, the second display unit 22 enlarges each of the images in regions E, F, and G so that the positional relationship and aspect ratio of each of the images displayed in each of regions E, F, and G of layout L12 of the third layer are not changed and so that the size and position of layout L10 of the uppermost layer before enlargement correspond. As shown at time t13 in FIG. 9, the second display unit 22 causes the size of layout L12 to be the same as the size of layout L10 of the uppermost layer. In the meantime, the second display unit 22 quits to display the images in the regions, for example, regions A, B, C, and D, which are included in layout L10 of the uppermost layer but which are not included in layout L12 of the third layer and the layouts of the layers lower than the third layer (step S2).

During the image display by the second display unit 22 or after the end of the image display by the second display unit 22, the third display unit 23 further generates, as a new layout L14, a part of the region divided by layout L13, for example, as shown in time t13 in FIG. 9. The third display unit 23 divides layout L14 to generate new regions I, etc. The third display unit 23 displays images such as still images or moving images associated with one another in the new regions I, etc. (step S3).

Subsequently, the second display unit 22 repeats steps S2 and S3, and displays images in the layouts shown at time t14 to time t18 in FIG. 9.

As described above, according to the second embodiment, each of the images is enlarged (zoomed in) from layout L12 of the third layer, and advantageous effects similar to those according to the first embodiment can be provided.

The present invention is not completely limited to the embodiments described above, and modifications of components can be made at the stage of carrying out the invention without departing from the spirit thereof. Further, various inventions can be made by properly combining the components disclosed in the embodiments described above. For example, some of all the components shown in the embodiments may be eliminated. Moreover, components in different embodiments may be suitably combined together.

The images are zoomed in from layout L2 of the second layer in the first embodiment, and the images are zoomed in from layout L12 of the third layer in the second embodiment. However, the present invention is not limited thereto. The images may be zoomed in from the layout of any layer.

The present invention is not completely limited to the embodiment described above, and modifications of components can be made at the stage of carrying out the invention without departing from the spirit thereof. Further, various inventions can be made by properly combining the components disclosed in the embodiment described above. For example, some of all the components shown in the embodiment may be eliminated. Moreover, components in different embodiments may be suitably combined together.

What is claimed is:

1. An image display method comprising:
displaying, on a display, multiple images in regions divided by layouts having a hierarchic structure of each layout, the each layout being substantially similar in geometric means from an upper layer to a lower layer each other; and
repeating processing more than once to sequentially switch displayed images, the processing comprising;
(1) enlarging each of the images displayed in each of the regions of a particular layer and layers lower than the particular layer, the particular layer not being the uppermost layer, so that the positional relationship and aspect ratio of each of the images are not changed and so that the size and position of the layout of the particular layer after the enlargement correspond to the size and position of the layout of the uppermost layer before the enlargement;
(2) quitting displaying of the images in the regions of the layers higher than the particular layer but not included in the regions of the particular layer and the layers lower than the particular layer;
(3) dividing at least one region of the lowermost layer by applying the layout to the at least one region to generate new regions; and
(4) displaying images in the generated regions.

2. The image display method according to claim 1,
wherein the aspect ratio of at least one of the regions divided by the layouts is a golden ratio or a silver ratio.

3. The image display method according to claim 1,
wherein the multiple images are associated with one another.

4. The image display method according to claim 1,
wherein the multiple images comprise still images or moving images.

5. The image display method according to claim 1,
wherein the resolution of the image displayed in the layout of the layer higher than a predetermined layer is raised to preset resolution.

6. The image display method according to claim 1,
wherein the enlargement of the images starts from the image of one of the layers lower than the uppermost layer.

7. An image display apparatus comprising;
a displaying unit having functions of:
displaying, on a display, multiple images in regions divided by layouts having a hierarchic structure of each layout, the each layout being substantially similar in geometric means from an upper layer to a lower layer each other; and
repeating processing more than once to sequentially switch displayed images, the processing comprising;
(1) enlarging each of the images displayed in each of the regions of a particular layer and layers lower than the particular layer, the particular layer not being the uppermost layer, so that the positional relationship and aspect ratio of each of the images are not changed and so that the size and position of the layout of the particular layer after the enlargement correspond to the size and position of the layout of the uppermost layer before the enlargement;
(2) quitting displaying of the images in the regions of the layers higher than the particular layer but not included in the regions of the particular layer and the layers lower than the particular layer;
(3) dividing at least one region of the lowermost layer by applying the layout to the at least one region to generate new regions; and
(4) displaying images in the generated regions.

8. The image display apparatus according to claim 7;
wherein the aspect ratio of at least one of the regions divided by the layouts is a golden ratio or a silver ratio.

9. The image display apparatus according to claim 7;
wherein the multiple images are associated with one another.

10. The image display apparatus according to claim 7, further comprising:
an image search unit which searches for the multiple images associated with one another by information regarding at least feature points, shapes, and colors in the images.

11. The image display apparatus according to claim 7;
wherein the multiple images comprise still images or moving images.

12. The image display apparatus according to claim 7;
wherein the second display unit raises the resolution of the image displayed in the layout of the layer higher than a predetermined layer to preset resolution.

13. The image display apparatus according to claim 7;
wherein the second display unit starts the enlargement from the image of one of the layers lower than the uppermost layer.

14. A computer-readable recording medium in which an image display program is recorded, the image display program causing a computer to:
display, on a display, multiple images in regions divided by layouts having a hierarchic structure of each layout, the each layout being substantially similar in geometric means from an upper layer to a lower layer each other; and
repeat processing more than once to sequentially switch displayed images, the processing comprising;
(1) enlarging each of the images displayed in each of the regions of a particular layer and layers lower than the particular layer, the particular layer not being the uppermost layer, so that the positional relationship and aspect ratio of each of the images are not changed and so that the size and position of the layout of the particular layer after the enlargement correspond to the size and position of the layout of the uppermost layer before the enlargement;
(2) quitting displaying of the images in the regions of the layers higher than the particular layer but not included in the regions of the particular layer and the layers lower than the particular layer;
(3) dividing at least one region of the lowermost layer by applying the layout to the at least one region to generate new regions; and
(4) displaying images in the generated regions.
